(19) United States
(12) Patent Application Publication
(10) Pub. No.: US 2022/0092473 A1
(43) Pub. Date: Mar. 24, 2022

(54) SYSTEM AND METHOD FOR PERFORMING TREE-BASED MULTIMODAL REGRESSION

(71) Applicant: Samsung Display Co., Ltd., Yongin-si (KR)

(72) Inventor: Janghwan Lee, Pleasanton, CA (US)

(21) Appl. No.: 17/127,778

(22) Filed: Dec. 18, 2020

Related U.S. Application Data
(60) Provisional application No. 63/080,558, filed on Sep. 18, 2020.

(51) Int. Cl. G06N 20/00; G06K 9/62

(52) U.S. Cl. CPC G06N 20/00; G06K 9/6289; G06K 9/6256

(57) ABSTRACT

A system and method for making predictions relating to products manufactured via a manufacturing process are disclosed. A processor receives input data and makes a first prediction based on the input data. The processor identifies a first machine learning model from a plurality of machine learning models based on the first prediction. The processor further makes a second prediction based on the input data and the first machine learning model, and transmits a signal to adjust the manufacturing of the products based on the second prediction.

### CROSS-REFERENCE TO RELATED APPLICATION(S)

The present application claims priority to and the benefit of U.S. Provisional Application No. 63/080,558, filed Sep. 18, 2020, entitled “TREE BASED MULTIMODAL REGRESSION FOR DISPLAY DEFECT VISIBILITY,” the entire content of which is incorporated herein by reference.

### FIELD

One or more aspects of embodiments according to the present disclosure relate machine learning systems, and more particularly, to predicting a manufacturing defect level via a tree structured multimodal regressor.

### BACKGROUND

The mobile display industry has grown rapidly in recent years. As new types of display panel modules and production methods are deployed, and as product specifications tighten, it may be desirable to enhance equipment and quality-control methods to maintain production quality. For example, it may be desirable to have measures for detecting different levels of manufacturing defects. Accordingly, what is desired is a system and method for automatically predicting levels of manufacturing defects for making adjustments to the manufacturing process.

The above information disclosed in this Background section is only for enhancement of understanding of the background of the present disclosure, and therefore, it may contain information that does not form prior art.

### SUMMARY

An embodiment of the present disclosure is directed to a method for making predictions relating to products manufactured via a manufacturing process. A processor receives input data and makes a first prediction based on the input data. The processor identifies a first machine learning model from a plurality of machine learning models based on the first prediction. The processor further makes a second prediction based on the input data and the first machine learning model, and transmits a signal to adjust the manufacturing of the products based on the second prediction.

According to one embodiment, the input data includes multivariate sensor data from a plurality of sensors.

According to one embodiment, the first machine learning model is associated with a first normal distribution associated with a first manufacturing condition, and a second machine learning model of the plurality of machine learning models is associated with a second normal distribution associated with a second normal distribution associated with a second manufacturing condition.

According to one embodiment, the second prediction is a prediction of a defect level associated with the products.

According to one embodiment, the processor generates the plurality of machine learning models including: applying a first baseline machine learning model to a training dataset; engaging in an error analysis process in response to applying the first baseline machine learning model, wherein the error analysis process identifies a first portion of the training dataset that is within a threshold range of error, and a second portion of the training dataset that is outside of the threshold range of error; labeling the first portion of the training dataset with a first label; and engaging in the error analysis process with a new baseline machine learning model for the second portion of the training dataset.

According to one embodiment, the error analysis process is executed a certain number of times based on a preset number of labels.

According to one embodiment, a different label is assigned in each execution of the error analysis process, to data in the training dataset that is within the threshold range of error.

According to one embodiment, the first prediction includes a predicted label, and the method for making predictions relating to products manufactured via a manufacturing process further comprises training a classifier based on the training dataset and labels generated by the error analysis process, wherein making the first prediction includes applying the classifier to the input data.

According to one embodiment, the method further comprises augmenting the input data with additional data, wherein the additional data is based on statistical information on data generated at a prior time period.

According to one embodiment, at least one of temperature or operating speed of a manufacturing equipment is adjusted in response to the signal.

An embodiment of the present disclosure is also directed to a system for making predictions relating to products manufactured via a manufacturing process. The system includes a processor and a memory. The memory includes instructions that, when executed by the processor, cause the processor to: receive input data; make a first prediction based on the input data; identify a first machine learning model from a plurality of machine learning models based on the first prediction; make a second prediction based on the input data and the first machine learning model; and transmit a signal to adjust the manufacturing of the products based on the second prediction.

As a person of skill in the art should recognize, the claimed system and method for making predictions relating to products manufactured via a manufacturing process help address changing manufacturing conditions that may result in changing relationships between input data and the predictions, while controlling model complexity and computation power in making predictions with desired accuracies.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 is a block diagram of a system for making predictions relating to products manufactured via a manufacturing process according to one embodiment;

FIG. 2 is a block diagram of an inference module according to one embodiment;

FIG. 3A is a flow diagram of a process executed by a training module for generating a plurality of machine learning models according to one embodiment;

FIG. 3B are example regressors generated upon execution of the flow diagram of FIG. 3A;

FIG. 4 is a more detailed flow diagram of a process for training a classifier engine according to one embodiment; and

FIG. 5 is a flow diagram of a process executed by a data augmentation module for augmenting collected trace data X during an inference stage according to one embodiment.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

A manufacturing process, such as a mobile display manufacturing process, may acquire digital trace data during the manufacture of the mobile display product. Although a mobile display product is used as an example, a person of skill in the art should recognize that embodiments of the present disclosure may apply to manufacturing processes of other glass and non-glass products, including for example, the manufacturing of semiconductor wafer, display glass, Poly Imide substrate, and/or the like.

Trace data may be collected via one or more sensors that may be placed, for example, on top of a conveyer belt that carries the product during production. The sensors may be configured to record a sensed activity as trace data. The sensors may be, for example, multiple temperature and pressure sensors configured to capture measurements of temperature and pressure in the manufacturing process, as a function of time. Each sensor may be sampled multiple times (e.g., every second or a few seconds for monitoring each glass, over a period of multiple glass manufacturing time).

Trace data may be analyzed to understand conditions that lead to certain manufacturing defects. As manufacturing conditions change over time, the collected trace data, and relationships of the trace data to manufacturing defects, may also change. When machine learning is used to predict manufacturing defects based on input trace data, a model that is trained based on a previously understood relationship may no longer function to accurately predict defects if the relationship between trace data and manufacturing defects has changed due to changes in manufacturing conditions. Accordingly, it is desirable to have a system and method that uses machine learning to make predictions of manufacturing defects, where the system and method also takes into account different/changing relationships between the trace data and the manufacturing defects in making the predictions.

In general terms, embodiments of the present disclosure are directed to analyzing trace data of a manufacturing process for predicting a degree/level of defect (also referred to as defect visibility level) of the manufacturing process. A defective manufacturing process may result in a defective/faulty manufacturing part. Identifying potential defects of the manufacturing process may help improve quality control of the process, reduce manufacturing costs, and/or improve equipment uptime.

In one embodiment, the trace data is generated by one or more sensors over time. The trace data is provided to an analysis system for predicting a defect visibility level. In one embodiment, the input trace data is provided by a plurality of the sensors as multivariate input data. The input trace data may be augmented using statistical information of previously obtained trace data, and the augmented data may be provided to a classifier for selecting a machine learning model (e.g. a regression model) from a plurality of models. The selected machine learning model may depend on a class label assigned by the classifier to the augmented data.

In one embodiment, the analysis system addresses varying manufacturing conditions that may result over time, which may create multiple single distributions (also referred to as multimodal distributions) of the input data (e.g. trace data) to the output data (e.g. defect visibility levels). In one embodiment, the analysis system provides a tree-structured multimodal regressor design to help address the multimodal distributions of the data. In this regard, the analysis system may provide a plurality of machine learning models, where a first model is associated with a first modality (e.g. a first normal distribution) that may be identified by a first class label, and a second model is associated with a second modality (e.g. a second normal distribution) different from the first modality, that may be identified by a second class label. In one embodiment, the classifier selects one of the plurality of machine learning models based on the class label that is predicted for the augmented input data. Experiments show that the tree-structured multimodal regressor design that uses a plurality of regressors for predicting defect levels achieves a higher prediction accuracy than a model that uses a single regressor.

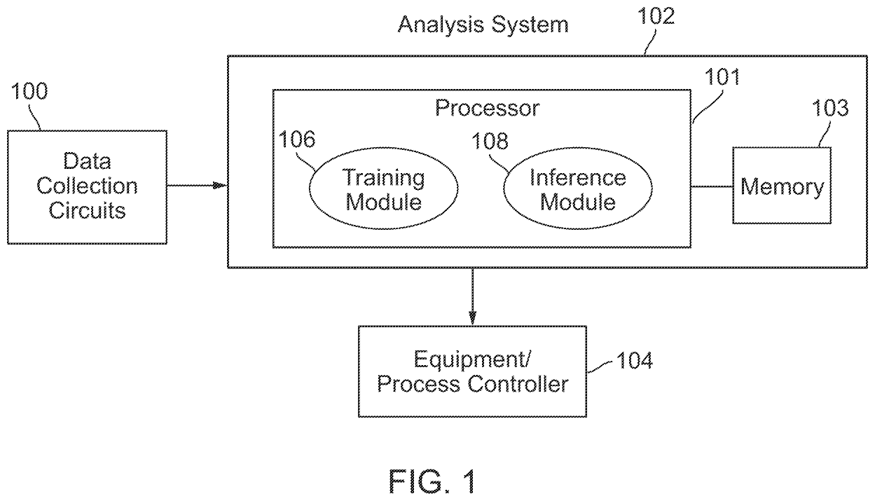

FIG. 1 is a block diagram of a system for making predictions relating to products manufactured via a manufacturing process according to one embodiment. The system includes one or more data collection circuits 100, an analysis system 102, and one or more equipment/process controllers 104. The data collection circuits 100 may include, for example, sensors, amplifiers, and/or analog to digital converters, configured to collect trace data during a manufacturing process. The sensors may be placed, for example, on top of a conveyer belt that carries a product during production. The sensors may be configured to record any sensed activity as trace data. For example, the sensors may be multiple temperature and pressure sensors configured to capture measurements of temperature and pressure in the manufacturing process, as a function of time. Each sensor may be sampled multiple times (e.g., every second or a few seconds for monitoring each glass, over a period of multiple glass manufacturing time).

The analysis system 102 may include a training module 106 and an inference module 108. Although the training and inference modules 102, 106 are illustrated as separate functional units in FIG. 1, a person of skill in the art will recognize that the functionality of the modules may be combined or integrated into a single module, or further subdivided into further sub-modules without departing from the spirit and scope of the inventive concept. For example, in some implementations, the training module 106 corresponds to one or more processing units (also referred to as a processor) 101 and associated memory 103. The inference module 108 may correspond to the same one or more processing units as the training module 106 or to a different one or more processing units. Examples of processing units include a central processor unit (CPU), a graphics processor unit (GPU), an application specific integrated circuit (ASIC). a field programmable gate array (FPGA), etc.

The training module 106 may be configured to generate and train a plurality of machine learning models for use by the inference module 108. The plurality of machine learning models may be generated and trained based on training data provided by the data collection circuits 100. In one embodiment, the training module 106 uses a tree-structured multimodal regressor design in generating and training the plurality of machine learning models.

The training module 106 may also be configured to train a classifier to select one of the plurality of machine learning models. In this regard, the plurality of machine learning models may be associated with different class labels. In one embodiment, the classifier is trained to learn a relationship between trace data and the class labels, to identify an appropriate machine learning model to use during an inference stage.

The inference module 108 may be configured to predict a defect visibility level based on trace data provided by the data collection circuits 100 during the inference stage. In this regard, the inference module 108 may select a model from the plurality of trained machine learning models to make the prediction. The selection of the model may depend on the classification of the received trace data. Different machine learning models may be invoked based on different classifications.

In one embodiment, the predicted defect visibility level is used for making an adjustment in the manufacturing process. For example, if the predicted defect visibility level is above a certain threshold level, a signal may be transmitted to the equipment/process controller 104 for adjusting a parameter of a manufacturing equipment used for the manufacturing process. The adjusted parameter may be, for example, an operating speed or internal temperature of the manufacturing equipment. In one embodiment, the manufacturing equipment may be re-initialized or re-calibrated in response to detecting that the predicted defect visibility level is above the certain threshold level.

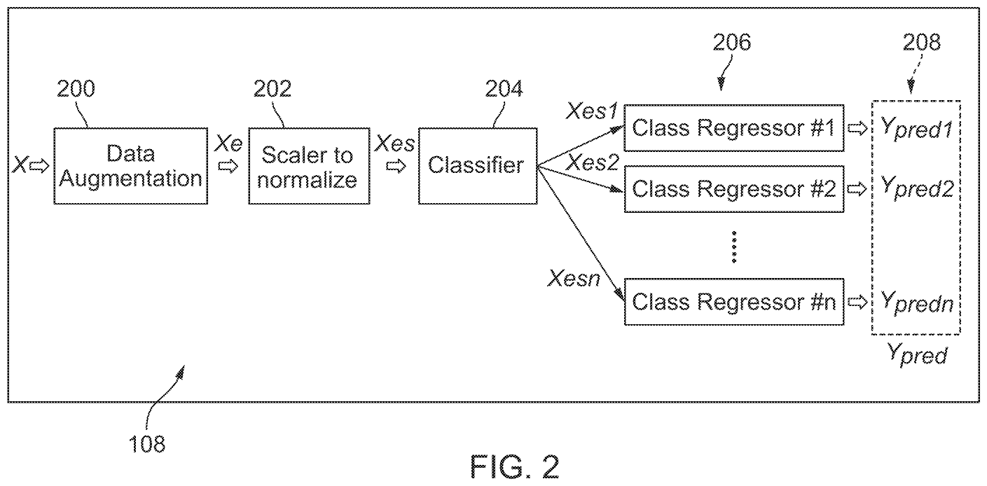

FIG. 2 is a block diagram of the inference module 108 according to one embodiment. In one embodiment, the inference module 108 includes a data augmentation module 200, a scaling module 202, a classifier engine 204, and a plurality of machine learning models 206 (also referred to as class regressors).

In one embodiment, trace data X is collected from the various sensors by the data collection circuits 100, and provided to the data augmentation module 200 as multivariate input data. The data augmentation module 200 may take the multivariate trace data and augment the trace data with statistical data. The statistical data may be, for example, a mean value computed from prior samples collected by the data collection circuits 100. The mean value may be concatenated to the collected trace data to produce an augmented dataset Xe.

In one embodiment, the augmented dataset Xe may be further processed by the scaling module 202. Because the range of values provided by the various sensors may vary widely depending on the type of sensor, the scaling module 202 may be configured to apply feature scaling/normalization to the augmented dataset Xe to produce a normalized dataset Xes. Data normalization may be achieved via a feature standardization algorithm, min-max normalization, or the like. The normalized dataset Xes may then be fed to the classifier engine 204.

The classifier engine 204 may be configured to run a machine learning algorithm such as, for example, random forest, extreme gradient boosting (XGBoost), support-vector machine (SVM), deep neural network (DNN), and/or the like. In one embodiment, the classifier engine 204 is trained to predict a class label for the input data. In this regard, the classifier engine 204 may predict a class label from a plurality of preset class labels. The predicted class label may then be used to select a machine learning model from the plurality of machine learning models 206. The selected machine learning model generates a prediction of a defect visibility level 208 of a product manufactured via the manufacturing process.

In one embodiment, each machine learning model of the plurality of machine learning models 206 is associated with a different modality. Each modality may reflect certain manufacturing conditions that result in a particular distribution of trace data to predicted defect visibility levels. The use of multimodal machine learning models 206 for predicting defect visibility levels may allow the analysis system to address changes in manufacturing conditions while providing a desired level of prediction accuracy. The use of multimodal machine learning models 206 may also help control model complexity and save computation power when compared to a system that uses a single model for making the predictions.

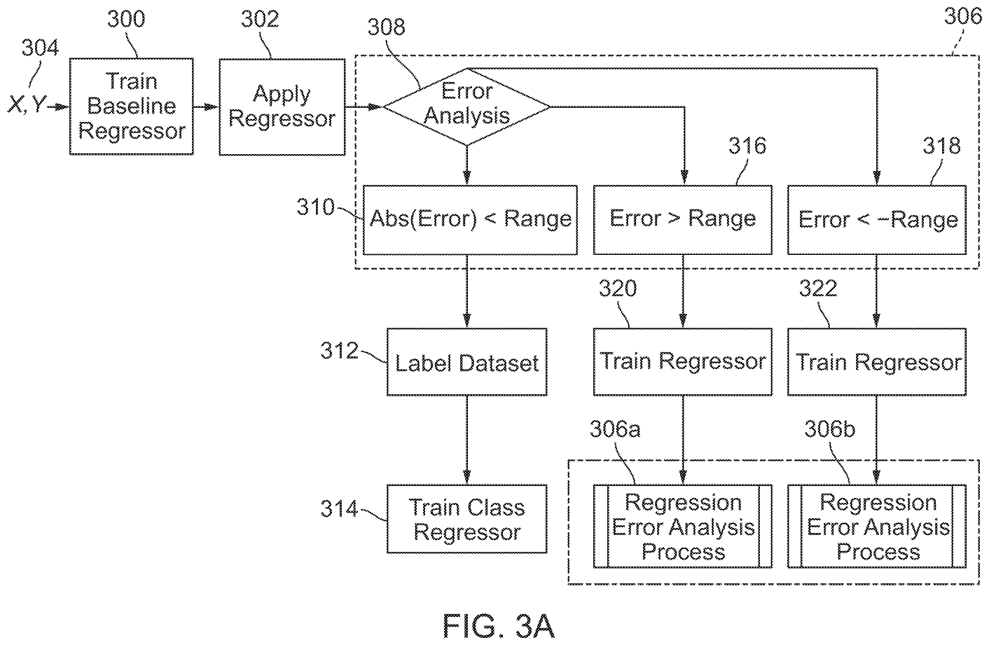

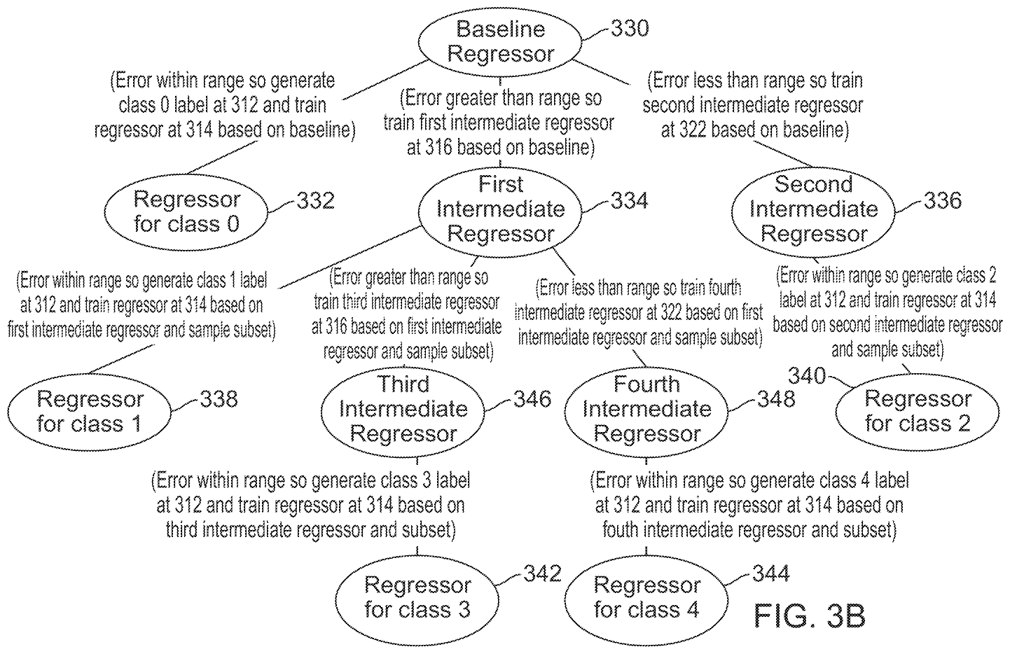

FIG. 3A is a flow diagram of a process executed by the training module 106 for generating the plurality of machine learning models 206 according to one embodiment. It should be understood that the sequence of steps of the process is not fixed, but can be modified, changed in order, performed differently, performed sequentially, concurrently, or simultaneously, or altered into any desired sequence, as recognized by a person of skill in the art. FIG. 3B are example regressors generated upon execution of the flow diagram of FIG. 3A

At block 300, the training module 106 builds a baseline regressor 330, and, at block 302, applies the baseline regressor 330 to an input training dataset 304 for predicting a defect visibility level. The baseline regressor 330 may be any machine learning model that may be simple to set up, such as, for example, a linear regression model. In one embodiment, the baseline regressor 330 is built using all training data to identify the major distribution of the input training dataset 304. The input training dataset 304 may consist of trace data (X) and related defect visibility levels (Y).

At block 306, the training module 106 iteratively engages in the error analysis process for identifying a subset of the input training dataset 304 that is within a threshold range of error. The error may be a value indicative of a difference between the predicted defect visibility level and the defect visibility level provided in the training dataset 304 as ground truth. In this regard, at block 308, the training module 106 engages in an error analysis inquiry for determining whether the prediction by the baseline regressor at block 302 for a first subset of the input training dataset 304 is within or outside the threshold range of error when compared to the ground truth visibility level. If the first subset of the input training dataset 304 is within the threshold range of error, such subset is identified at block 310.

At block 312, the training module 106 labels the identified first subset with a class label. The class labels may be, for example, automatically generated numbers (e.g. sequential numbers). For example, the first generated class label may be class “0,” and the applied baseline regressor 330 may be set as a regressor 332 for class 0. At block 314, the training module 106 trains the classifier 204 using one or more machine learning models, for learning the relationship between the identified first subset and the assigned class label.

Referring again at block 308, if any second subset of the input training dataset 304 is outside of the threshold range of error (e.g. greater than a positive threshold value as identified at block 316, or less than a negative threshold value as identified at block 318, although other values are also possible), such second subset is identified at the appropriate block 316 or 318. At block 320 or 322, the training module 106 proceeds to build and train a new baseline regressor (e.g. first intermediate regressor 334), and engages in the error analysis process again at block 306a or 306b, upon applying the new baseline regressor to the second subset. If, by running the error analysis process 306a, 360b, it is determined that the new baseline regressor is within the threshold range of error, the second subset is labeled with a new class label in block 312. For example, the class label for the second subset may be class “1,” and the applied first intermediate regressor 334 may be set as a regressor 338 for class 1.

In one embodiment, the error analysis process 306a, 306b repeats until all data in the input training dataset is within the threshold range of error, or until a maximum depth value has been reached. The maximum depth value may be based on a preset number of class labels identified by the training module. For example, if the preset number of class labels is four (classes 0-3), the error analysis process repeats a maximum of four times for identifying a maximum number of four regressors (e.g. regressors 332, 338, 340, 342, and 344) and associated subset of datasets for each of the classes. According to one embodiment, if after the last repetition there is still data in the input training dataset that is outside the threshold range of error, the remaining data may be merged with data in a prior repetition, and assigned the class label of the prior repetition.

In one embodiment, the process executed by the training module 106 for generating the plurality of machine learning models 206 may be described as a tree algorithm that iteratively segments the input training dataset 304 and, depending on the error analysis, either labels the segmented dataset with a label (by traversing to a left sub-branch of the tree), or applies one or more new intermediate baseline regressors (e.g. intermediate regressors 334 or 336 during a first iteration of the process, or intermediate regressors 346 or 348 during a second iteration of the process) to perform the error analysis again (by traversing to right sub-branches of the tree). In one embodiment, the depth of the tree may be limited (e.g. to be the total number class labels determined by the training module 106) for limiting implementation complexity.

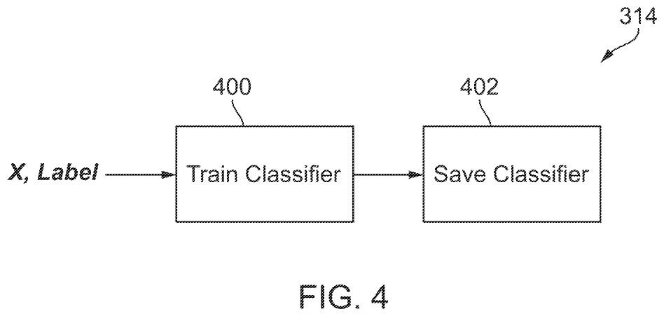

FIG. 4 is a more detailed flow diagram of block 314 for training the classifier engine 204 according to one embodiment. The classifier engine 204 may be ready for training after the input training dataset 304 has been labeled with corresponding class labels. In this regard, at block 400, input data including training trace data (X) and associated labels, is used for training the classifier engine 204 to learn the relationship between the trace data and the associated labels. The training may be done via a supervised machine learning algorithm such as, for example, a classification algorithm. Once trained, the classifier engine 402 may be saved at block 402. The trained classifier may be ready for use by the inference module 108.

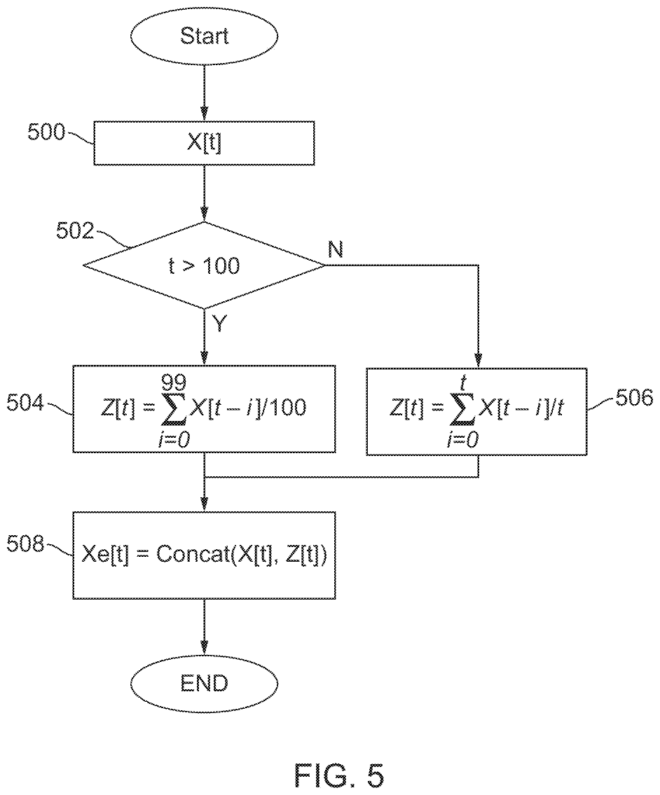

FIG. 5 is a flow diagram of a process executed by the data augmentation module 200 for augmenting the collected trace data X during an inference stage according to one embodiment. In one embodiment, the trace data is augmented based on statistical information of prior samples. The statistical information may be a mean, standard deviation, moment, or the like. The augmenting of the trace data with statistical information may help provide a temporal context to the input data, such as, for example, information that the data is increasing or decreasing in value over time.

In one embodiment, the process for data augmentation starts, and at block 500, the data augmentation module 200 identifies an original input vector generated from the collected trace data.

At block 502, a determination is made as to whether a preset number (e.g. 100) of prior samples may be identified corresponding to the original input vector. If more than the preset number of prior samples may be identified, the data augmentation module 200 determines, in block 504, statistical information of the current and prior samples. The statistical information may be, for example, a mean value of the prior samples.

Referring again to block 502, if less than the preset number of prior samples is identified, the statistical information is determined based on the available number of current and prior samples at block 506.

At block 508, a statistical information vector generated based on the determined statistical information (e.g. a mean value vector) is concatenated to the original input vector. The statistical information may also include standard deviation, median, mode, or the like.

In some embodiments, the various modules and engines described above are implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

It will be understood that when an element or layer is referred to as being “on”, “connected to”, “coupled to”, or “adjacent to” another element or layer, it may be directly on, connected to, coupled to, or adjacent to the other element or layer, or one or more intervening elements or layers may be present. In contrast, when an element or layer is referred to as being “directly on”, “directly connected to”, “directly coupled to”, or “immediately adjacent to” another element or layer, there are no intervening elements or layers present.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein.

Although exemplary embodiments of a system and method for detecting manufacturing defect levels have been specifically described and illustrated herein, many modifications and variations will be apparent to those skilled in the art. Accordingly, it is to be understood that a system and method for detecting manufacturing defect levels constructed according to principles of this disclosure may be embodied other than as specifically described herein. The disclosure is also defined in the following claims, and equivalents thereof.

What is claimed is:

1. A method for making predictions relating to products manufactured via a manufacturing process, the method comprising:
receiving, by a processor, input data;
making, by the processor, a first prediction based on the input data;
identifying, by the processor, a first machine learning model from a plurality of machine learning models based on the first prediction;
making a second prediction based on the input data and the first machine learning model; and
transmitting a signal to adjust the manufacturing of the products based on the second prediction.

2. The method of claim 1, wherein the input data includes multivariate sensor data from a plurality of sensors.

3. The method of claim 1, wherein the first machine learning model is associated with a first normal distribution associated with a first manufacturing condition, and a second machine learning model of the plurality of machine learning models is associated with a second normal distribution associated with a second normal distribution associated with a second manufacturing condition.

4. The method of claim 1, wherein the second prediction is a prediction of a defect level associated with the products.

5. The method of claim 1 further comprising:
generating, by the processor, the plurality of machine learning models including:
applying a first baseline machine learning model to a training dataset;
engaging in an error analysis process in response to applying the first baseline machine learning model, wherein the error analysis process identifies a first portion of the training dataset that is within a threshold range of error, and a second portion of the training dataset that is outside of the threshold range of error;
labeling the first portion of the training dataset with a first label; and
engaging in the error analysis process with a new baseline machine learning model for the second portion of the training dataset.

6. The method of claim 5, wherein the error analysis process is executed a certain number of times based on a preset number of labels.

7. The method of claim 5, wherein a different label is assigned in each execution of the error analysis process, to data in the training dataset that is within the threshold range of error.

8. The method of claim 5, wherein the first prediction includes a predicted label, the method further comprising:
training a classifier based on the training dataset and labels generated by the error analysis process, wherein making the first prediction includes applying the classifier to the input data.

9. The method of claim 1 further comprising:
augmenting the input data with additional data, wherein the additional data is based on statistical information on data generated at a prior time period.

10. The method of claim 1, wherein at least one of temperature or operating speed of a manufacturing equipment is adjusted in response to the signal.

11. A system for making predictions relating to products manufactured via a manufacturing process, the system comprising:
a processor; and
a memory, wherein the memory includes instructions that, when executed by the processor, cause the processor to:
receive input data;
make a first prediction based on the input data;
identify a first machine learning model from a plurality of machine learning models based on the first prediction;
make a second prediction based on the input data and the first machine learning model; and
transmit a signal to adjust the manufacturing of the products based on the second prediction.

12. The system of claim 11, wherein the input data includes multivariate sensor data from a plurality of sensors.

13. The system of claim 11, wherein the first machine learning model is associated with a first normal distribution associated with a first manufacturing condition, and a second machine learning model of the plurality of machine learning models is associated with a second normal distribution associated with a second normal distribution associated with a second manufacturing condition.

14. The system of claim 11, wherein the second prediction is a prediction of a defect level associated with the products.

15. The system of claim 11, wherein the instructions further cause the processor to:
generate the plurality of machine learning models including:
applying a first baseline machine learning model to a training dataset;
engaging in an error analysis process in response to applying the first baseline machine learning model, wherein the error analysis process identifies a first portion of the training dataset that is within a threshold range of error, and a second portion of the training dataset that is outside of the threshold range of error; and
labeling the first portion of the training dataset with a first label; and
engaging in the error analysis process with new baseline machine learning models for the second portion of the training dataset.

16. The system of claim 15, wherein the error analysis process is executed a certain number of times based on a preset number of labels.

17. The system of claim 15, wherein a different label is assigned in each execution of the error analysis process, to data in the training dataset that is within the threshold range of error.

18. The system of claim 15, wherein the first prediction includes a predicted label, wherein the instructions further cause the processor to:
train a classifier based on the training dataset and labels generated by the error analysis process, wherein making the first prediction includes applying the classifier to the input data.

19. The system of claim 11, wherein the instructions further cause the processor to:
augment the input data with additional data, wherein the additional data is based on statistical information on data generated at a prior time period.

20. The system of claim 11, wherein at least one of temperature or operating speed of a manufacturing equipment is configured to be adjusted in response to the signal.
